(19) United States
(12) Patent Application Publication
(10) Pub. No.: US 2008/0305256 A1
(43) Pub. Date: Dec. 11, 2008

(54) Method for producing lithium vanadium polyanion powders for batteries

(75) Inventors: James B. Kimble, Monument, CO (US); Zhenhua Mao, Ponca City, OK (US); Edward J. Nanni, Ponca City, OK (US); Edward G. Latimer, Ponca City, OK (US)

Correspondence Address: ConocoPhillips Company - IP Services Group;Attention: DOCKETING, 600 N. Dairy Ashford, Bldg. MA-1135, Houston, TX, 77079, US

(73) Assignee: CONOCOPHILLIPS COMPANY, Houston, TX (US)

(21) Appl. No.: 12/024,038

(22) Filed: Jan. 31, 2008

Related U.S. Application Data
(60) Provisional application No. 60/933,866, filed on Jun. 8, 2007.

(51) Int. Cl. B05D 3/00; C01B 25/45

(52) U.S. Cl. 427/215; 423/641

(57) ABSTRACT

This invention relates to a process for producing an improved cathode powder for making lithium ion batteries wherein the powder comprises lithium, vanadium and a polyanion. The process includes forming a solution-suspension of the precursors, which include vanadium pentoxide, with a reducing agent, a solvent, and a carbon-residue-forming material. The reducing agent causes the vanadium in vanadium pentoxide to reduce from V5+ to V3+. The solution-suspension is heated in an inert environment to drive the synthesis of the LVP (Li₃V₂(PO₄)₃) such that the carbon-residue-forming material is also oxidized to precipitate in and on the LVP forming carbon-containing LVP or CCLVP. The liquids are separated from the solids and the dry powder is heated to a second higher temperature to drive the crystallization of the product. The resulting product retains a small particle size, includes carbon in the LVP for conductivity and is created with very low cost precursors and avoids the need for milling or other processing to reduce the product to a particle size suitable for use in batteries. It also does not require the addition of carbon black, graphite or other form of carbon to provide the conductivity required for use in batteries.

### CROSS-REFERENCE TO RELATED APPLICATIONS

This application claims the benefit of U.S. provisional patent application Ser. No. 60/933,866, filed Jun. 8, 2007.

### STATEMENT REGARDING FEDERALLY SPONSORED RESEARCH OR DEVELOPMENT

None

### FIELD OF THE INVENTION

This invention relates to materials for use in the positive electrode of lithium-ion batteries and processes for making such materials.

### BACKGROUND OF THE INVENTION

Lithium-ion batteries are recognized and valued for high efficiency, energy density, high cell voltage and long shelf life and have been in commercial use since the early 1990's. As always though, there is a desire to make better batteries for less cost.

A key component of current lithium-ion batteries is a lithium transition-metal polyanionic powder that is provided as the active material on the metal plates at the positive electrode. Iron, cobalt, manganese, and nickel transition-metal powders have been used and other transition metals have been considered. Cobalt has high performance but has proven to be unsafe because of the potential for explosion during recharging. Iron is attractive because of its low cost, but does not provide the energy density of other transition-metals such as cobalt and nickel. Vanadium has been proposed, but has yet to be used commercially, probably because of the higher expense and limited success in obtaining any advantage over other, more developed systems.

Many methods have been investigated to synthesize various lithium transition-metal polyanionic powders. These methods include solid-state reactions, carbon thermal reduction, and hydrogen reduction methods. However, there are several problems with each of these methods. The major problems include a) agglomeration of particles, b) incomplete reactions, c) the existence or presence of undesirable components within the starting materials and their subsequent presence in the final products, d) poor electrochemical properties of the resulting materials, and e) the requirement for expensive precursors and/or complicated processes.

These lithium transition metal polyanionic powders are most typically synthesized using a solid state reaction. Starting materials in particle form are mixed to produce an intimate mixture of particles. When heat is applied to effect reaction, the solid particles react with one another through a variety of surface reactions accompanied by diffusion of reactive materials into and out of the various particles in the mixture. For this reason, it is preferred to first provide particles with the desired particle size and then mix these particles to create a mixture with the precursors highly dispersed throughout to obtain a high degree of contact for a high yield of the desired product. To accomplish this, the particle mixtures are typically prepared by methods such as ball-milling or physical mixing. Since the particles of the active materials may be relatively large and/or the sizes may be non-uniform, optimum conditions of surface to surface contact between particles is often not well achieved.

For these above reasons, it would be desirable to provide a better method for synthesizing battery active materials.

U.S. Pat. No. 5,910,382 to Goodenough et al (hereafter “Goodenough”) describes improvements to cathode materials for rechargeable lithium batteries and especially the inclusion of polyanions such as (PO₄)³⁻. While Goodenough seems to prefer manganese, iron, cobalt and nickel, Goodenough notes that vanadium is a cheaper and less toxic transition metal than the already developed systems using cobalt, nickel and manganese.

U.S. Pat. No. 5,871,866 to Barker et al (hereafter “Barker”) describes a number of lithium transition metal oxide formulations for use in the cathode of lithium-ion batteries. Lithium vanadium phosphate (Li₃V₂(PO₄)₃ or “LVP”) is one of the specifically discussed examples.

Barker and Goodenough each describe the process for producing the cathode powders comprising a solid state reaction described above wherein the precursors are intermingled to form an essentially homogenous powder mixture. There is discussion in each describing the powder precursors being pressed into pellets to get better grain to grain contact and several intermittent milling steps during synthesis of the materials.

U.S. Pat. No. 6,913,855 to Stoker et al (hereafter “Stoker”) also describes an array of lithium transition metal oxide formulations for use in the cathode of lithium-ion batteries including LVP. Stoker blends the precursors in a slurry that may include a solvent with some precursors being partially dissolved in the solvent. The slurry apparently provides the desired dispersion of the precursors. The slurry is then spray dried prior to starting the reaction to produce the desired product. Like Barker, one option used to obtain the closely cohering-reaction mixture is to compress the spray dried powder into tablets.

### SUMMARY OF THE INVENTION

The present invention improves the state of the art of batteries and materials useful in the production of batteries.

The present invention provides an improved process for making a carbon containing lithium vanadium phosphate powder.

The present invention preferably comprises a process for making carbon containing lithium vanadium polyanionic powder comprising a first step of dissolving and dispersing the precursors including a source of lithium, vanadium pentoxide (V₂O₅), a polyanionic compound and a reducing agent to form a liquid solution-suspension. The solution-suspension is heated to a first temperature at which the reducing agent reduces the five valence state vanadium (V5⁺) to three valence state vanadium (V³⁺) and the precursors, including the three valence vanadium, form a lithium vanadium polyanionic precipitate. The precipitate is separated from the liquid and heated to a second temperature. During the process the lithium vanadium polyanionic particles are coated with a carbon-residue-forming material which is crystallized and carbonized at the second temperature producing the powder.

Another embodiment of the present invention comprises a process for making carbon containing lithium vanadium phosphate powder comprising a first step of dissolving and dispersing the precursors including a source of lithium, vanadium pentoxide (V₂O₅), a phosphate, a reducing agent and a carbon-residue-forming material (CRFM) in an solvent to form a solution-suspension. The solution-suspension is heated to a first temperature to cause the reducing agent to reduce the five valence state vanadium (V⁵⁺) to three valence state vanadium (V³⁺) and LVP particles are synthesized and precipitate. The CRFM at least partially participates due to the reduction of the vanadium, which in turn oxidizes the CRFM, causing it to become less soluble and to precipitate on and within the LVP particles. The solids are then separated from the liquid so as to produce a loose powder and the powder is then heated to a second higher temperature to drive the formation of a highly crystalline structure within the Li₃V₂(PO₄)₃ particles and to carbonize the CRFM.

The present invention alternatively comprises a process for making carbon containing lithium vanadium phosphate powder comprising a first step of combining the precursors including a source of lithium, vanadium pentoxide (V₂O₅), a phosphate, a carbon-residue-forming material and an solvent/rcducing agent that is selected to dissolve the lithium source and also cause the reduction of the vanadium pentoxide. The precursors form a solution-suspension. The solvent/reducing agent causes the reduction of the five valence vanadium V⁵⁺ to three valence vanadium V³⁺. The solution-suspension is heated to a first temperature to synthesize the LVP particles while at the same time, the CRFM is also oxidized and becomes less soluble in the solution, consequently precipitating on and in the solid particles. The liquids and solids are then separated so as to produce a loose powder and the powder is then heated to a second higher temperature to drive the formation of a highly crystalline structure within the particles of Li₃V₂(PO₄)₃ and to carbonize the CRFM.

### BRIEF DESCRIPTION OF THE DRAWINGS

The invention, together with further advantages thereof, may best be understood by reference to the following description taken in conjunction with the accompanying drawings in which:

FIG. 1 is a block diagram showing the inventive process for making LVP;

FIG. 2 is a block diagram showing an alternative embodiment of the inventive process for making LVP;

FIG. 3 is a block diagram showing a second alternative embodiment of the inventive process for making LVP;

FIG. 4 is a block diagram showing a third alternative embodiment of the inventive process for making LVP;

FIG. 5 is a block diagram showing a fourth alternative embodiment of the inventive process for making LVP;

FIG. 6 is a block diagram showing a fifth alternative embodiment of the inventive process for making LVP;

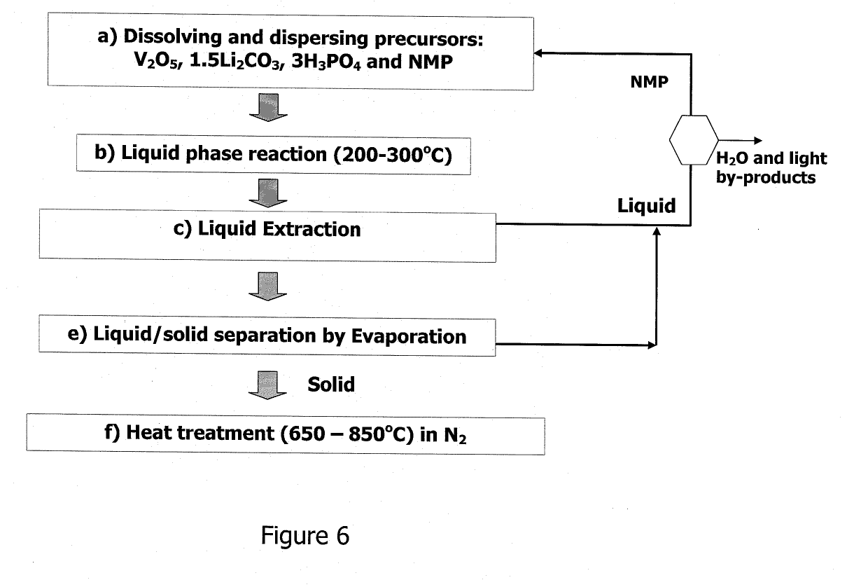

FIG. 7 is chart showing the electrode potential profiles of powder made from the inventive processes of the present invention; and

FIG. 8 is a chart showing capacity loss of powders made using the inventive processes over a number of cycles.

### DETAILED DESCRIPTION OF THE INVENTION

This invention includes several facets or aspects. To aid in the discussion and understanding of the invention as it relates to various parameters and qualities for batteries, several definitions are provided for comparison of the materials of the present invention with prior art materials or materials from prior art methods.

As used herein, the following terms have their usual meanings in the art and are intended to specifically include the following definitions:

Capacity (mAh/g): The amount of electrical charge that can be stored in and released from a given electrode material per unit weight within a certain defined electrode potential window.

Coulombic Efficiency (%): The ratio of the amount of electrical charge discharged from an electrode material to the amount of electrical charge that is used to charge the electrode to the state before discharge.

A “carbon-residue-forming material” (CRFM) is any material which, when thermally decomposed in an inert atmosphere to a carbonization temperature of 600° C. or an even greater temperature, forms a residue which is substantially carbon. “Substantially carbon”, as used herein, indicates that the material is at least 95% carbon by weight.

“Carbonization” is a process that converts a carbon-containing compound to a material that is characterized as being “substantially carbon”.

Turning now more specifically to the invention, this invention relates to a method for making fine LVP powders. The fine LVP powder is particularly useful as a positive electrode material for high power lithium-ion batteries. In this invention, a preferred embodiment of these powders are produced with a carbon-coating or carbon containing which we describe as CCLVP. It is believed that CCLVP has improved efficiency, capacity, stability or energy loss as compared with other cathode powders. It is further believed that lithium-ion batteries made with the CCLVP from this invention results in improved performance as compared with lithium-ion batteries made with other cathode powders.

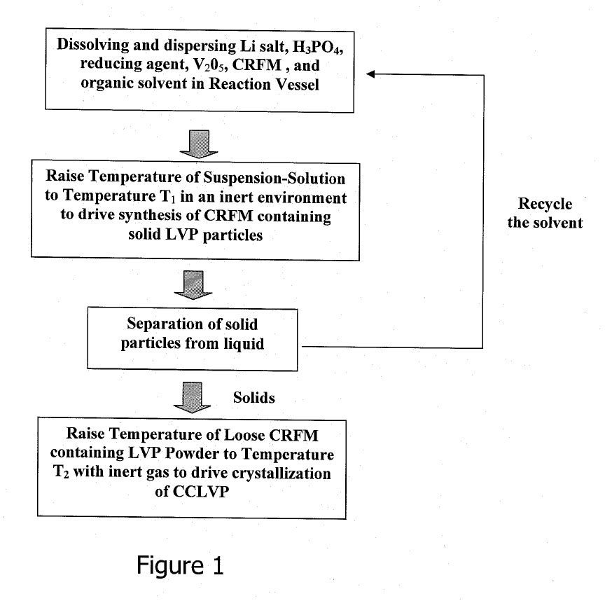

FIG. 1 shows a process flow diagram that sets forth one embodiment of the invention. In this embodiment, the precursors required for the process include a source of vanadium, a source of lithium, a phosphate, a CRFM, an solvent and a reducing agent. A single compound may serve as more than one of the precursors and specifically the solvent may also serve as a reducing agent.

Prior to the first step in the process of combining the precursors, the precursors are selected and prepared. For instance, the vanadium pentoxide is milled in a ball mill to a small particulate size preferably to an average particle size of less than 30 micrometers, more preferably less than 15 micrometers, still more preferably less than 8 micrometers and 5 micrometers or smaller is most preferred. While higher purity precursors are always preferred, it is not necessary that expensive precursors be selected if low cost precursors are available.

The preferred precursors for the CCLVP product are five valence vanadium oxide (V₂O₅) powder as the vanadium source, lithium carbonate (Li₂CO₃) or lithium hydroxide (LiOH) as the lithium source, and phosphoric acid (H₃PO₄), ammonium hydrate phosphate ((NH₄)₂HPO₄) or ammonium phosphate NH₄H₂PO₄ as the phosphate or polyanion source, a carbon-residue-forming material (CRFM), a solvent and a reducing agent. One of ordinary skill in the art will recognize that there are a large number of polyanion-containing compounds which could be used as source of the polyanions required in the final lithium vanadium polyanionic product. Without limitation, examples of CRFMs include petroleum pitches and chemical process pitches, coal tar pitches, lignin from pulp industry; and phenolic resins or combinations thereof. The CRFM may comprise a combination of organic compounds such as acrylonitrile and polyacrylonitriles; acrylic compounds; vinyl compounds; cellulose compounds; and carbohydrate materials such as sugars. Especially preferred for use as CRFMs are petroleum and coal tar pitches and the reaction products of NMP.

The solvent is chosen so that it dissolves some of the precursors, is stable at the desired reaction temperature, and does not dissolve the resulting product. In addition, the solvent preferably has a high boiling point such that the solvent can act as medium for a higher valence vanadium to be reduced to a lower valence state, as described below. Preferred solvents include water and high boiling point polar organic compounds such as NMP (n-methyl-pyrrolidone, n-methyl-2-pyrrolidinone, or 1-methyl-2-pyrrolidone), ethylene carbonate and propylene carbonate. Other examples of suitable solvents include alcohols, acids, nitrites, amines, amides, quinoline, and pyrrolidinones, etc. and mixture of these solvents. Optionally and preferably, the solvent may also be used as the reducing agent. In this case, the solvent is reactive with transition metal precursors. Thus, the solvent/reducing agents include liquid organic compounds, such as alcohols, hydrocarbons, and carbohydrates, which are moderately safe and low toxicity.

The phosphoric acid and solvent/reducing agent, as noted above, are preferably liquids at ambient conditions and are selected so as to dissolve the lithium hydroxide and CRFM. The ratio of the CRFM to solvent/reducing agent determines the amount of carbon precipitate which forms in the solution-suspension. While the vanadium pentoxide generally does not dissolve all the way to form a true solution, it has been observed that the particle size of the product is smaller than the particle size of the precursor vanadium pentoxide. As such, it is believed that the vanadium continuously dissolves into the solution as the reduction of V⁵⁺ proceeds during heating and as such, it is described as a solution-suspension.

As the precursors are mixed the reducing agent causes the reduction of the vanadium pentoxide from a five valence state (V⁵⁺) to the three valence state (V³⁺), simultaneously, solid LVP particles precipitate out of the solution, and CRFM is also oxidized and becomes less soluble in the solution, consequently precipitating on and in the solid particles. Stoichiometrically, the three valence vanadium is best suited for the synthesis of LVP.

After the precursors, reducing agent, and solvent are mixed, the mixture is heated in inert atmosphere such as nitrogen, helium, argon, carbon monoxide, and carbon dioxide gas, etc. while the solution/suspension is agitated. The temperature is controlled to be less than 400° C., preferably below 300° C., even below 250° C., but is at least 50° C. Heating drives the precursors and reducing agent to react and form the desired LVP compound, which is substantially close to the final product in stoichiometric composition. The presence of the solvent prevents the resulting fine particles from growing and agglomerating. Therefore, it is desirable to control the concentration of solid particles in the reaction solution to achieve the desired particle size and control or limit agglomeration of the particles. The total solid content in the reaction solution should be between 5% to 70% by weight. It is recognized that higher theoretical productivity would be attained with a higher solids content and it is assumed that there will be limiting factors at higher solids content in the solution-suspension. So, it is preferred that the solids content be between 10% and 70% of the solution-suspension by weight, and more preferably above 20% by weight.

The next step is separating the powder from the liquid. Any conventional method for solid-liquid separation, such as, for example, centrifugal separation, or filtration, can be used to separate the LVP from the solution. Where the precursor materials are of high quality and contain few or no impurities that would be deleterious to the final product, separation can be achieved by simply evaporating the solvent during the subsequent crystallization step. As shown in FIG. 1, the solvent liquid may optionally be recycled back to the first step of combining the precursors. It is believed that impurities in the precursors generally remain in the liquid because after separating the solid particle powder from the liquid, the resulting powder has a very high purity of the stoichiometric composition of the desired final LVP crystalline product. The material at this stage also remains as a loose powder, and typical primary particle size is less than 1 μm even though the resulting powder may contain some particle agglomerates.

A significant benefit of the inventive method for producing LVP is that contaminants, impurities or non-desired materials are less likely to be present in the final product. Most of the non-desired materials are separated from the intermediate solid product when it is separated from the solvent because most of the impurities will remain dissolved in the solution. In a solid state reaction, contaminants, impurities or non-desired materials including those contained in the precursors or formed as byproducts of the reactions are more likely to be carried into the final product.

One particular advantage of the present invention is that including the CRFM with the other precursors at appropriate ratios results in two desired reactions occurring almost simultaneously. The reducing agent reduces the vanadium from the V⁵⁺ to the V³⁺ valence state and the vanadium oxidizes the CRFM, causing it to become less soluble and to precipitate on and probably within the resulting LVP particles. This small amount of elemental carbon provides improved electrical conductivity in the LVP that is highly desired for use in batteries. As such, the LVP is described to be carbon-containing or CCLVP.

The CCLVP, as yet, does not have the degree of crystallinity that is desired for the final product. The temperature of the CCLVP powder is increased to a temperature higher than 300° C. in an inert atmosphere. The heating treatment temperature should be between 400 and 1000° C., preferably between 500 and 900° C., more preferably between 650 and 850° C. The resulting mixture remains as a loose powder. The heating at this step provides the necessary condition to form the desired crystalline structure for the final product.

It has been found that if the carbon-content of the resulting particles is not greater than 0.1 wt %, then the CCLVP powder does not have sufficient electrical conductivity to perform in a battery without some additional materials. Graphite or carbon black may be used as is well known in the art. More preferably a carbon coating as described in U.S. Pat. No. 7,323,120 and also in PCT Published Application Number WO 2007/082217 may be applied to the low carbon content powder (<0.1 wt %) to provide the electrical conductivity. Essentially, this additional coating process comprises applying the coating on the powder while the powder is suspended in a solution of CRFM using a selective precipitation method. The CCLVP with the CRFM coating is then heat treated to convert the CRFM to carbon and to bond the carbon coating firmly to the CCLVP particle. The heating temperature at this step should be between 500 and 1000° C., preferably between 600 and 900° C., more preferably between 700 and 900° C. The amount of carbon on and in the CCLVP is preferably above 0.5 wt % and up to about 10 wt %, but between 0.5 wt % to about 5 wt % is preferred and between 1 wt % and 3 wt % is most preferred.

Although carbon coating has been discussed, the preferred embodiment of the present invention is to create CCLVP having the preferred carbon content without having to provide additional carbon through additional steps. As noted above, the preferred carbon content is between 0.5 wt % and 10 wt %, preferably between 0.5 wt % and 5 wt %, and between 1 wt % and 3 wt % being most preferred.

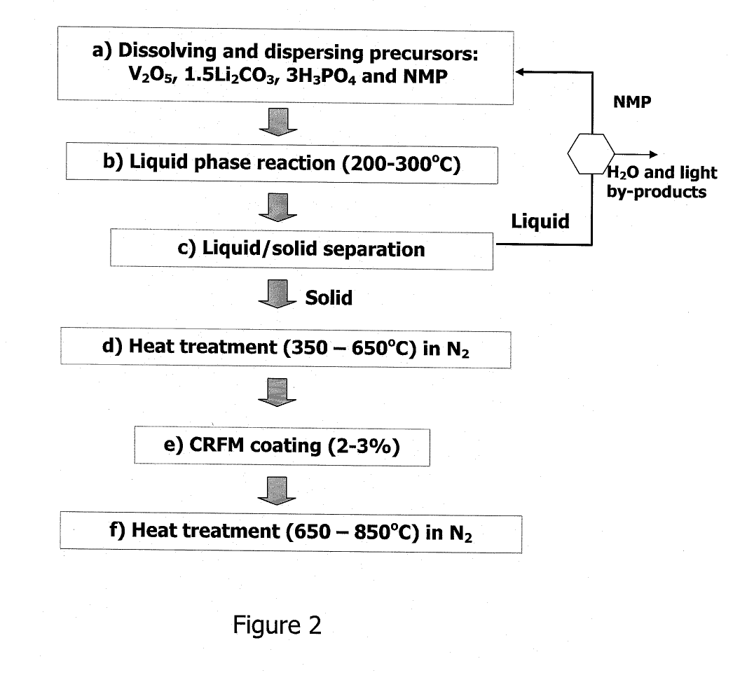

Turning now to focus on several variations or embodiments of the inventive process, FIG. 2 indicates that the precursors are five valence vanadium, lithium carbonate, phosphoric acid and NMP. The precursors are heated up to a temperature between about 200° C. and about 300° C. such that the NMP reduces the five valence vanadium and synthesizes the LVP as a precipitate. The liquid is recycled through a process that eliminates water and light byproducts and the solid is pass on to an intermediate heat treat up to a temperature between about 350° C. and about 650° C. The liquid-solid separation is accomplished by mechanical separation such as vacuum filtration, centrifugal separation or other known means. After the intermediate heat treatment to create a more stable particle size and shape in the LVP, a pitch coating step is accomplished by selective precipitation, as described in U.S. Pat. No. 7,323,120. Briefly, the CRFM is dissolved in a solvent and combined with the LVP. The carbon is selectively precipitated on the particles at about 1% to 10% by weight. The coated LVP particles are then separated from the solvent and the particles are subjected to a third heat treatment to carbonize the carbon coating. The carbon coating may be first stabilized by a heat treatment process and then carbonized at a higher temperature or may be carbonized without being first stabilized.

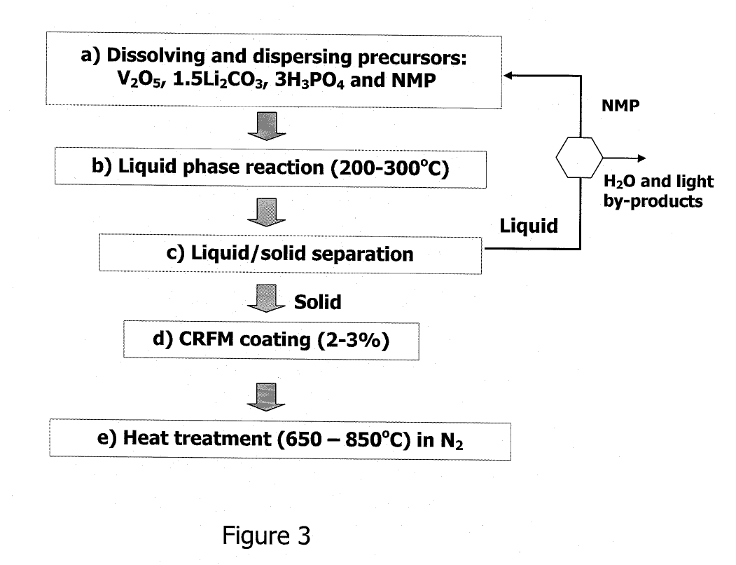

In FIG. 3, the process is similar to that shown in FIG. 2 except that the intermediate heating step is omitted. The intermediate heating step is preferred, but is not necessary to practice the invention and produce CCLVP powder.

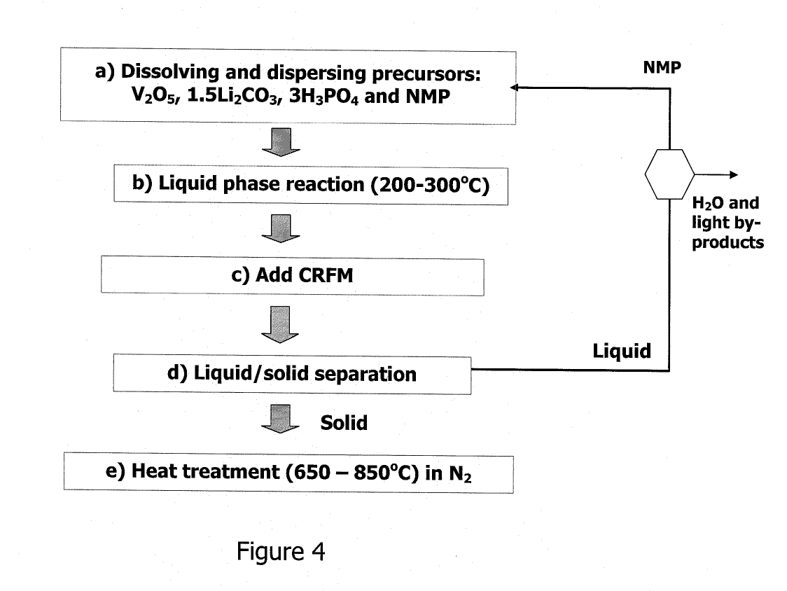

In FIG. 4, the process is similar to that shown in FIG. 3 with the difference being that the CRFM is added to the suspension-solution after the first heating step and prior to the liquid-solid separation. This embodiment, therefore, has the advantage of eliminating a solid-liquid separation step.

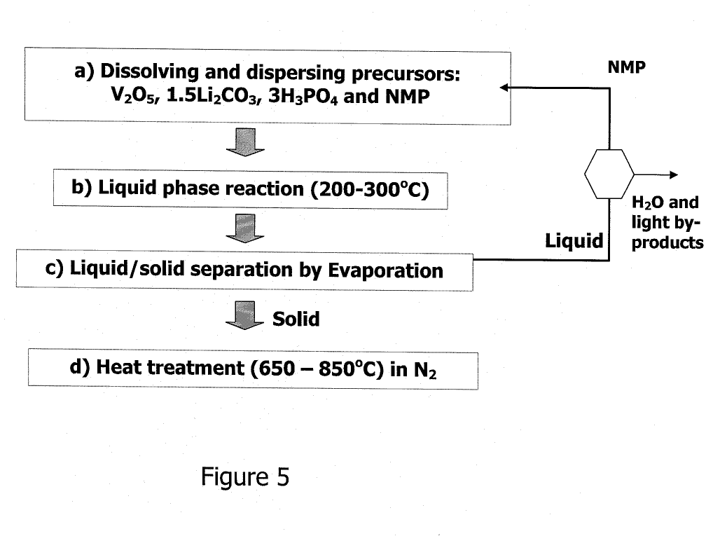

FIG. 5 shows an interesting aspect of the present invention where the carbon-residue-forming material is actually contributed by the NMP oxidation-reduction reaction with the five valence vanadium. Oxidation of the NMP produces water and carbon-yielding materials that remain in solution after the first heating step and do not evaporate if the LVP particles are separated from the liquid by evaporation. These carbon-yielding materials can be used to coat the LVP. In this embodiment, the particle-liquid separation is accomplished by evaporation so as to keep the carbon-yielding compounds with the LVP precipitate. The carbon-yielding material provides a well distributed coating on the surfaces of the LVP particles. As such, the carbon-yielding material from the NMP can serve as a substitute for the CRFM.

In a more preferred arrangement, and taking advantage of what is set out in FIG. 5, is a process where at least part or all of the liquid is separated by filtration or other mechanical means and an amount of the liquid is metered back to the solid LVP to provide a desired and controlled level of coating on the particles. As noted above, the desired range is between about 2% and 3% and a higher amount of carbon-forming material may be created by the oxidation-reduction process. If an insufficient amount of carbon-residue-forming material is present, an additional amount of CRFM may be added at step (d) to provide a fully controlled coating process on the formed LVP particles.

It should be apparent that the inventive process may be practiced using a variety of variables as controls for optimal results. The stoichiometry is believed to be close to optimal when one mole of V₂O₅ is combined with 1.5 moles of Li₂CO₃ and three moles of phosphoric acid.

It should be noted that all the heat treatments are typically and preferably performed in a controlled manner such as, for example, increasing the temperature at 5° C. per minute up to the desired temperature and the desired temperature is held for a predetermined period of time before the source of heat is removed and the temperature is allowed to return to ambient temperature naturally. This procedure of “ramping and holding” the temperature is well known to those of ordinary skill in the art.

### EXAMPLES

### Example 1

9.27 grams of V₂O₅ powder (99.2%, Alfa Chemical) were ball-milled with 150 ml of NMP for about 10 minutes, and subsequently transferred into a beaker. 17.3 grams of 86% phosphoric acid (H₃PO₄) were slowly poured into the beaker while the suspension was stirred continuously. 5.547 grams of lithium carbonate (Li₂CO₃) were then slowly added into the beaker while it was stirred continuously. The resulting solution/suspension contained solid vanadium pentoxide and dissolved lithium hydrogen phosphate. 1.5 grams of a petroleum pitch were dissolved in the suspension. The resulting suspension was transferred into a 500 ml stainless steel pressure vessel, 7.5 g of n-butanol (CH₃(CH₂)₃OH) was subsequently added to the vessel.

The suspension was heated in the pressure vessel at 250° C. for 3 hours while the suspension was continuously agitated. The suspension was allowed to cool to room temperature. The resulting solid particles were separated from the liquid by filtration, and then dried at 100° C. under vacuum overnight. The total weight of the dried powder was 22.56 gram.

The resulting powder was transferred into a 50-ml ceramic crucible, placed in a tube furnace, and subsequently heated at the following sequences under a nitrogen gas atmosphere: one hour at 350° C.; one hour at 450° C.; and 15 hours at 650° C. The furnace was then allowed to cool to room temperature and the resulting powder was retrieved from the furnace. The total weight of the recovered powder was 20.33 grams. This is the base material for further processing, as described in Examples 2 and 3. The electrochemical properties of Example 1 was tested as the cathode material for Li-ion batteries.

### Example 2

5 grams of the sample in Example 1 was heated further at 850° C. for 6 hours in a nitrogen gas atmosphere. The resulting powder weighed 4.91 g, and remained as a loose flowable powder. The carbon content and electrochemical properties of Example 2 are given in Table 1 below.

### Example 3

Pitch coating and carbonization—The product powder made in Example 1 was coated with pitch. First, 14.4 grams of the product powder was dispersed in xylene. Then, 2.20 grams of petroleum pitch were dissolved in about 2.2 grams of xylene and heated to 90° C. The pitch/xylene solution was combined with the powder/xylene suspension and the combined suspension was heated at 140° C. for 10 minutes under continuous agitation. The heat was subsequently removed to let the suspension cool to room temperature. The resulting solid powder was separated by filtration and dried at 100° C. under vacuum. The resulting powder weighed 14.8 grams, yielding about 2.8% pitch by weight.

The above pitch-coated powder was placed in a tube furnace and heated in nitrogen gas under the following sequences: the temperature was ramped up at a rate of 1° C./minute to 250° C., held at 300° C. for 4 hours, ramped at 1° C./m to 400° C., held at 400° C. for 2 hours, and then cooled down to room temperature. The powder was removed from the furnace and blended in a plastic bottle. Subsequently, the powder was placed back in the furnace and heated under a nitrogen atmosphere with the following sequences: 450° C. for 1 hour, 650° C. for 1 hour, and 850° C. for 6 hours. The resulting powder remained loose and flowable and it did not need to be milled further. The electrochemical properties and carbon content of this Example 3 were tested and the results are presented in Table 1.

Analysis of carbon content—The samples in Examples 2 and 3 were analyzed for their carbon content in the following manner: 1 gram of each sample was dissolved in 50 ml of 15 wt % acidic aqueous solution (9 wt % HCl, 3 wt % HNO₃, and 3% H₂SO₄) at ambient temperature (˜22° C.). The insoluble residual solid was separated by filtration, washed thoroughly with deionized water, and dried at 100° C. under vacuum for at least 2 hours. The resulting insoluble powder was weighed and was determined to be elemental carbon by energy dispersive X-ray fluorescence spectroscopy.

Electrochemical evaluation—The powders made in the above examples were evaluated as the cathode material for lithium ion batteries as follows: The powders were fabricated into electrodes for coin cells and then tested in the coin cells as described below.

Electrode Preparation—A desired amount of the powder was mixed with acetylene carbon black powder, fine graphite powder (<8 μm), and polyvinylidene fluoride (PVDF) solution (NMP as the solvent) to make a slurry. The slurry was cast on 20-μm thick aluminum foil. The slurry coated foil was dried on a hot plate. The dried solid film contained 2% carbon black, 4% graphite, 4% PVDF, and 90% Li₃V₂(PO₄)₃ powder. The film was trimmed into 5-cm strips and pressed through a hydraulic rolling press so that the density of the solid film was about 2.0 g/cc. The thickness or the mass loading of the solid film was controlled to be about 6 mg/cm². However, to test the samples in Examples 1 and 2, the electrode composition was 85 wt % of the active material, 5 wt % carbon black, 5% graphite, and 5% PVDF because the samples were thought to be less electrically conductive than Example 3.

Electrochemical tests—Disks of 1.41 cm in diameter were punched out from the pressed films and used as the positive electrode in standard coin cells (size CR2025) with lithium metal as the negative electrode. The separator used in the coin cells was a glass matt (Watman® Glass microfibre filter, GF/B), and the electrolyte was 1 M LiPF₆ in a mixture of solvents (40% ethylene carbonate, 30% methyl carbonate, and 30% diethyl carbonate). The test scheme was as follows: The cells were charged under a constant current of 0.5 mA (˜50 mA/g) until the cell voltage reached 4.2 volts, and charged further at 4.2 volts for one hour or until the current dropped to below 0.03 mA. Then the cells were discharged at constant current of 0.5 mA until the cell voltage reached 3.0 volts. Charge/discharge cycles were repeated to determine the stability of the materials during cycling. The capacity of the materials was calculated based on the passed electrical charge during discharging, while the coulombic efficiency was calculated based on the ratio of the discharge capacity to the capacity on charging. All the tests were conducted using an electrochemical test station (Arbin Model BT-2043). All experiments were conducted at room temperature (˜22° C.).

A comparison of the capacities and coulombic efficiencies at the 1^{st} and 10^{th} cycles is given in Table 1 for the powders made in examples 1, 2 and 3. The carbon content of the samples in Examples 2 and 3 are listed in Table 1.

### Comparative Example

This example used V₂O₃ powder as the vanadium source instead of V₂O₅. In addition, no butanol was added in this example. The solid particle powder at the pre-reaction step was separated from the suspension by evaporating the liquid. The rest of the steps were the same as in Example 1.

The data in Table 1 clearly show that the Li₃V₂(PO₄)₃ powder of Example 1 was superior to that in the comparative example in terms of the 1^{st} cycle capacity and coulombic efficiency. It is noted that it contained about 3.3% elemental carbon, as indicated for the sample in Example 2. As the reaction temperature was increased from 650° C. to 850° C., the capacity of the material increased significantly. However, pitch-coating and subsequent carbonization did not increase the capacity, as shown for Example 3. The capacities in columns 1 and 3 of Table 1 were based on the total weight, the capacities given in the last column were based on Li₃V₂(PO₄)₃ only (total weight minus carbon content). It can be seen that the capacity of both the samples in Examples 2 and 3 is very close to the theoretical value, 131.5 mAh/g and that the pitch-coating barely affects the capacity.

TABLE 1

| | 1st cycle | | 10th cycle | | | |
|---|---|---|---|---|---|---|
| | | Coulombic | | Coulombic | Carbon | Capacity less |
| | Capacity | efficiency | Capacity | efficiency | content | carbon |
| Example | (mAh/g) | (%) | (mAh/g) | (%) | (%) | (mAh/g) |
| 1 | 117.8 | 96.3 | 118.0 | 99.6 | ~3.3 | |
| 2 | 124.9 | 95.6 | 125.9 | 99.7 | 3.3 | 130.2 |
| 3 | 119.3 | 95.3 | 119.9 | 99.5 | 6.7 | 128.6 |
| comparative | 100.1 | 91.3 | 99.9 | 98.1 | | |

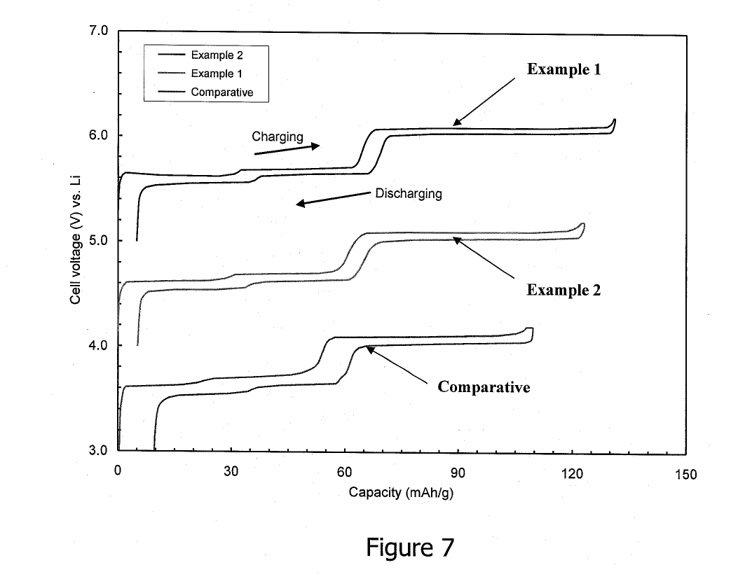

For a comparison of the electrode potential profiles during charging and discharging on the first cycle for the three samples, refer to FIG. 7. All the potential profiles exhibit the typical characteristics of Li₃V₂(PO₄)₃ materials: three plateaus at ˜3.6, 3.7 and 4.1 volts vs. Li, respectively. However, there are some differences in the plateau length and the hysteresis between charging and discharging curves among the three samples. Example 2 exhibits longer plateaus and less hysteresis than the other two, indicating that the material is more reversible than the others.

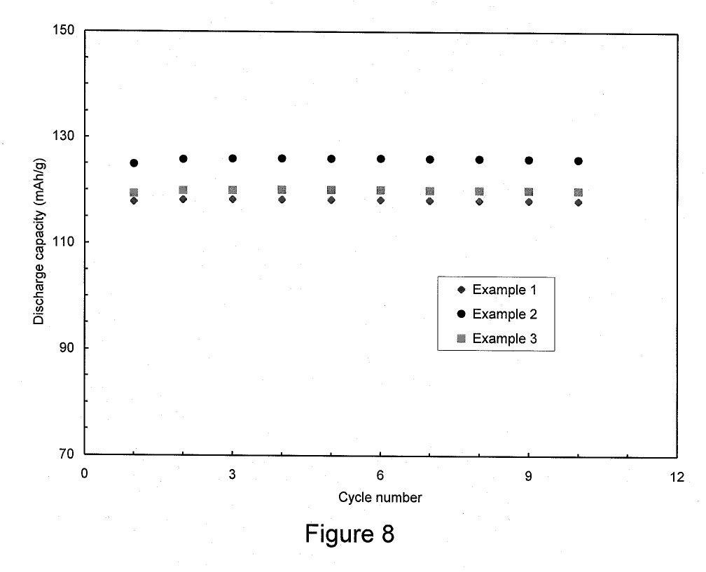

As shown in Table 1, the capacities of the materials in examples 1 through 3 increased slightly after 10 cycles. FIG. 8 shows the capacities of these samples at different cycles. All the powders exhibited no loss of capacity within 10 cycles.

Thus, it has been illustrated that the process according to this invention yielded carbon-containing Li₃V₂(PO₄)₃ powders that exhibit excellent electrochemical properties as cathode materials for Li-ion batteries. This new process is simple and it uses the least expensive precursors available. The usefulness of the process reflects not only on the synthesis of loose flowable powders, but also on the superior functionality of the resulting materials. Moreover the inventive process can also be used to make other lithium metal polyanion compound powders for lithium ion battery cathodes.

Accordingly, the scope of protection is not limited by the description set out above, but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of any reference in this application is not an admission that it is prior art to the present invention, especially any reference that may have a publication date after the priority date of this application.

1. A process for producing a fine lithium cathode battery powder wherein the process comprises the steps of:
a. dispersing and dissolving precursors including a lithium containing compound, a polyanion containing compound and vanadium pentoxide (V₂O₅), in an organic solvent/reducing agent to form a suspension-solution;
b. heating the suspension-solution to a first elevated temperature to cause the organic solvent/reducing agent to reduce the vanadium pentoxide from the 5+ valence state to the 3+ valence state and simultaneously cause the formation of lithium vanadium polyanion solid particles; and
c. separating the solid particles from the liquids.

2. The process according to claim 1, wherein the step of combining the precursors is further characterized in that the lithium containing compound is a lithium salt.

3. The process according to claim 2, wherein the lithium salt comprises at least one of lithium carbonate (Li₂CO₃), lithium hydroxide (LiOH) and combinations thereof.

4. The process according to claim 1, wherein the step of combining the precursors is further characterized in that the polyanion containing compound is one of phosphoric acid (H₃PO₄), ammonium phosphate, and mixtures thereof.

5. The process according to claim 1, wherein the step of combining the precursors further characterized in that the organic solvent/reducing agent comprises a high boiling point polar solvent.

6. The process according to claim 5, wherein the high boiling point polar solvent is NMP which is also described alternatively by the names n-methyl-pyrrolidone, n-methyl-2-pyrrolidinone and 1-methyl-2-pyrrolidone.

7. The process according to claim 1, wherein the step of heating is performed in an inert atmosphere.

8. The process according to claim 1, further including a step of coating the particulate powder with a carbon-residue-forming material by selective precipitation after step c) of separating the solids from the liquid, and further including the step of heating the solid particles to a second temperature in an inert environment at a temperature sufficient to crystallize the lithium vanadium polyanionic sold particles and carbonize the carbon-residue-forming material coating.

9. The process according to claim 8, further including a step of heating the particulate powder to an intermediate temperature to further stabilize the size and shape of the solid particles in the lithium vanadium polyanion after step c) of separating the solids from the liquid and prior to the step of coating the solid particles with the carbon-residue-forming material.

10. The process according to claim 1, wherein the liquid removed from the solid at step c) is recycled back to step a) to disperse and dissolve precursors.

11. The process according the claim 10, further including a separation step in the liquid recycle so as to separate water and light by-products from the organic solvent/reducing agent that is directed to the step a) of dispersing and dissolving precursors.

12. The process according to claim 1 wherein the step c) of separating the solid particles from the liquid is accomplished by mechanical separation such as filtration, centrifugal separation or gravity separation.

13. The process according to claim 1 wherein the step c) of separating the solids from the liquid is accomplished by evaporating the liquid from the solid.

14. The process according to claim 1 wherein the step c) of separating the solids from the liquid is accomplished by a first step of mechanical liquid extraction such as filtration, centrifugal separation, or gravity separation, and a second step of separating the solid particles from the liquid by evaporation.

15. The process according to claim 14, wherein the solid particles are coated with carbon-residue-forming material created by the oxidation of NMP in step a) and wherein the coating is between about 1 and 10 weight percent of the solid particles and further including a second heating step performed in an inert environment at a temperature sufficient to crystallize the lithium vanadium polyanionic solid particles and carbonize the carbon-residue-forming material coated on the solid particles.

16. The process according to claim 15, wherein the coating comprises between about 1 and 3 weight percent of the solid particles.

17. A process for producing a fine lithium cathode battery powder wherein the process comprises the steps of:
a. dispersing and dissolving precursors including a lithium containing compound, a polyanion containing compound, a reducing agent and vanadium pentoxide (V₂O₅) in a solvent to form a suspension-solution;
b. heating the suspension-solution to a first elevated temperature to cause the reducing agent to reduce the vanadium pentoxide from the 5+ valence state to the 3+ valence state and simultaneously cause the formation of lithium vanadium polyanion solid particles;
c. separating the solid particles from the liquid; and
d. heating the solid particles to a second elevated temperature that is higher than said first elevated temperature to drive the formation of a highly crystalline structure within the lithium vanadium polyanion solid particles.

18. The process according to claim 20, wherein both steps of heating are performed in an inert atmosphere.

19. A process for producing a fine lithium cathode battery powder wherein the process comprises the steps of:
a. dispersing and dissolving precursors including a lithium containing compound, a phosphate containing compound and vanadium pentoxide (V₂O₅) in an organic solvent/reducing agent to form a solution-suspension;
b. heating the suspension-solution to a first elevated temperature to cause the organic solvent/reducing agent to reduce the vanadium pentoxide from the 5+ valence state to the 3+valence state and simultaneously cause the formation of lithium vanadium phosphate solid particles;
c. separating the solid particles from the liquid; and
d. heating the solid particles to a second elevated temperature that is higher than said first elevated temperature to drive the formation of a highly crystalline structure within the carbon containing lithium vanadium phosphate solid particles.

20. The process according to claim 19 wherein the step c) of separating the solids from the liquid is accomplished by a first step of mechanical liquid extraction such as filtration, centrifugal separation, or gravity separation, and a second step of separating the solid particles from the liquid by evaporation, prior to heating the solid particles to the second temperature.

21. The process according to claim 20, wherein the solid particles are coated with carbon-residue-forming-material created by the oxidation of NMP in step b) and wherein the coating is between about 1 and 10 weight percent of the solid particles and wherein the second heating step is performed in an inert environment at a temperature sufficient to carbonize the carbon-residue-forming material coated on the solid particles.

22. The process according to claim 24, wherein the coating comprises between about 1 and 3 weight percent of the solid particles.
